(19) United States
(12) Patent Application Publication
(10) Pub. No.: US 2009/0129742 A1
(43) Pub. Date: May 21, 2009

(54) IMAGING APPARATUS, INFORMATION RECORDING APPARATUS, AND INFORMATION RECORDING METHOD

(75) Inventor: Takeshi TAKAMIYA, Iruma-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/247,800

(22) Filed: Oct. 8, 2008

(30) Foreign Application Priority Data
Nov. 16, 2007 (JP) 2007-298416

(51) Int. Cl. G11B 27/00; H04N 5/91

(52) U.S. Cl. 386/56; 386/46; 386/E05.003; G9B/27

(57) ABSTRACT

According to one embodiment, an imaging apparatus is provided with a recording module which records image data, a communication module which transits the image data to an external recording apparatus for backup, a preparing module which prepares a management list where information indicating whether the image data has been backed up and information indicating whether overwriting can be performed on a recording region on the recording module are caused to correspond to the image data, and a display module which displays the prepared management list.

### CROSS-REFERENCE TO RELATED APPLICATIONS

This application is based upon and claims the benefit of priority from Japanese Patent Application No. 2007-298416, filed Nov. 16, 2007, the entire contents of which are incorporated herein by reference.

### BACKGROUND

1. Field

One embodiment of the invention relates to an imaging apparatus in which, for example, a HDD (hard disk drive) or the like is incorporated as means for recording digitized information data, an information recording apparatus, and an information recording method.

2. Description of the Related Art

As is well known, in an imaging apparatus such as, a video camera incorporated HDD as recording means for digitally recording image data, it is necessary to cause another external recording media to copy and save image data recorded in a hard disk thereof, namely, perform the so-called backup.

By backing up image data recorded on a hard disk in this manner, it is made possible to overwrite new image data on a recording region of image data whose backup has been completed, so that the recording region can be used in a repetitive manner without causing overflow of the hard disk.

Now, a large number of image data items have been recorded on a hard disk and much troublesome work and much time are required in order for a user to perform setting about whether overwrite is conducted on respective image data items respectively. The setting work causes an error easily so that erroneous setting of a region to be overwritten results in disappearance of a necessary image data item.

Jpn. Pat. Appln. KOKAI Publication No. 11-112919 discloses that, when a user operates an overwrite mode selection switch to set an overwrite mode, an overwrite mode message is displayed and when running out of a free space on a hard disk, overwriting of video signal is started from a record region of the oldest data item on a hard disk based upon date information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block configuration diagram for explaining a simple overview of an imaging system according to one embodiment of the present invention;

FIGS. 2A and 2B are views for explaining an appearance of a digital video camera configuring the imaging system according to the embodiment, respectively;

FIG. 3 is a block configuration diagram for explaining an optical system and an electric system of the digital video camera configuring the imaging system according to the embodiment;

FIG. 4 is a diagram showing a blocked function performing a system control module of the digital video camera configuring the imaging system according to the embodiment;

FIG. 5 is a diagram for explaining a management list prepared by the digital video camera configuring the imaging system according to the embodiment;

FIG. 6 is a diagram for explaining one example of an overwrite automatic setting switching screen displayed on the digital video camera configuring the imaging system according to the embodiment;

FIG. 7 is a flowchart for explaining a processing operation performed by the digital video camera configuring the imaging system according to the embodiment;

FIG. 8 is a flowchart for explaining another processing operation performed by the digital video camera configuring the imaging system according to the embodiment;

FIG. 9 is a diagram for explaining one example of remaining amount display prepared by the digital video camera configuring the imaging system according to the embodiment;

FIG. 10 is a diagram for explaining a display aspect of the remaining amount display prepared by the digital video camera configuring the imaging system according to the embodiment;

FIG. 11 is a flowchart for explaining another processing operation performed by the digital video camera configuring the imaging system according to the embodiment; and

FIG. 12 is a block configuration diagram for explaining a simple overview of another system to which the present invention is applied.

### DETAILED DESCRIPTION

Various embodiments according to the invention will be described hereinafter with reference to the accompanying drawings. In general, according to one embodiment of the invention, an imaging apparatus is provided with a recording module which records image data, a communication module which transits the image data to an external recording apparatus for backup, a preparing module which prepares a management list where information indicating whether the image data has been backed up and information indicating whether overwriting can be performed on a recording region on the recording module are caused to correspond to the image data, and a display module which displays the prepared management list.

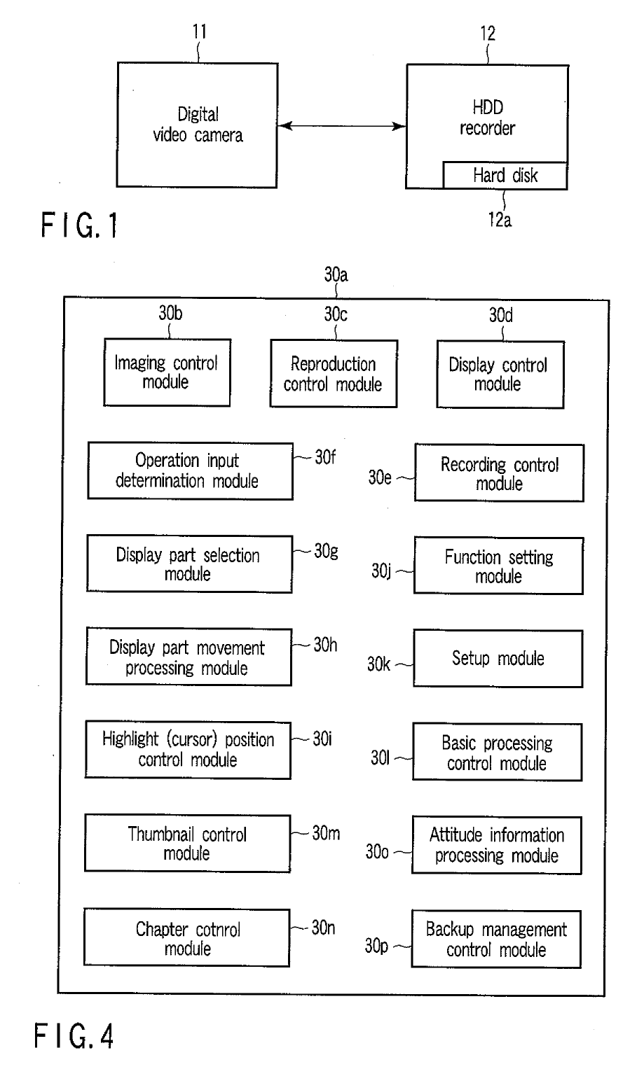

One embodiment of the present invention will be explained in detail below with reference to the drawings. FIG. 1 shows a simple overview of an imaging system explained in the embodiment. The imaging system comprises a digital video camera 11 serving as an imaging apparatus and a HDD recorder 12 serving as a recording apparatus which performs backup of data to the digital video camera 11.

The digital video camera 11 can perform imaging or shooting in a HD (high definition)—compliant manner, and image data obtained thereby is recorded in an incorporated hard disk (not shown). The image data recorded on the hard disk in the digital video camera 11 is copied to a hard disk 12a of the HDD recorder 12 and backed up therein according to the request of users.

At this time, the HDD recorder 12 produces a backup completion notification about the image data recorded on the hard disk 12a to output the same to the digital video camera 11. Thereby, the digital video camera 11 manages information about which image data has been backed up based upon the backup completion notification to determine an overwrite region on the hard disk.

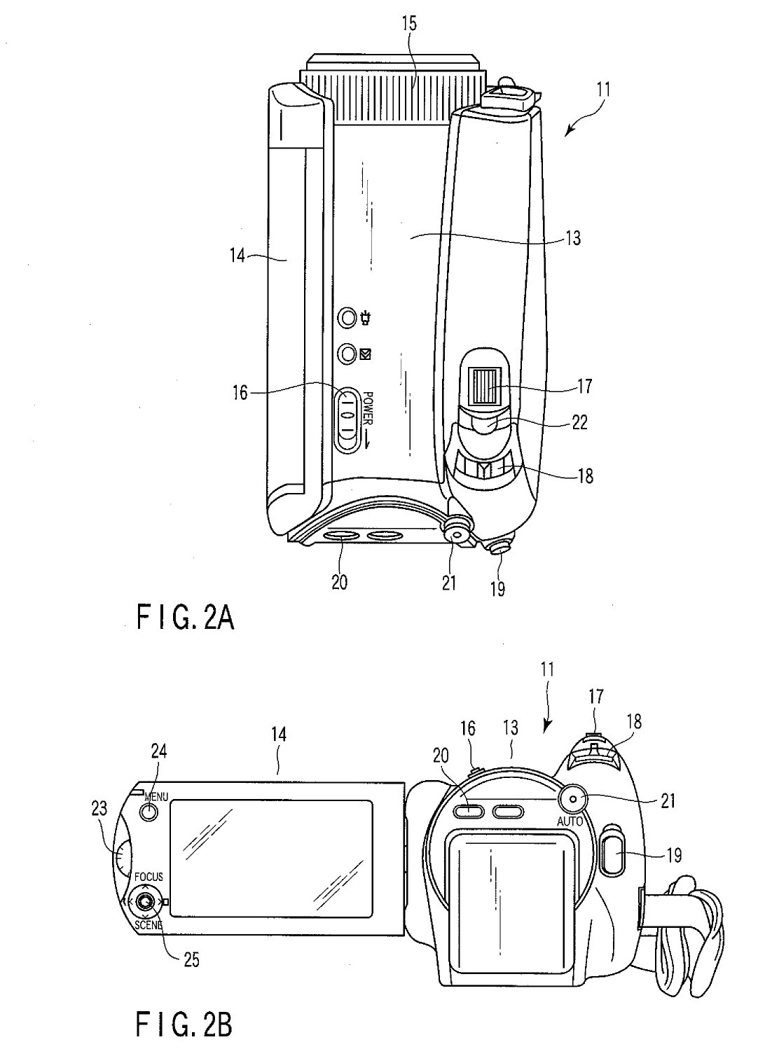

FIGS. 2A and 2B show appearances of the digital video camera 11, respectively. FIG. 2A shows a state of the digital video camera 11 viewed from the above thereof, and FIG. 2B shows a state of the digital video camera 11 viewed from the back side thereof. The digital video camera 11 mainly comprises a camera main body 13, a display panel 14, and a lens module 15.

The camera main body 13 of these members or modules is provided with a power source switch 16, a zooming lever 17, an imaging/reproduction switching switch 18, an imaging switch 19, a chapter switch 20, an automation setting switch 21 a still image imaging switch 22, and the like.

The power source switch 16 is for performing switching among power states of the digital video camera 11. The zooming lever 17 is for adjusting a focal length of a lens in the lens module 15. The imaging/reproduction switching switch 18 is for performing switching an operation mode of the digital video camera 11 between an imaging mode for imaging video and a reproduction mode for reproducing image data recorded.

The imaging switch 19 performs recording of image data of video when the operation mode of the digital video camera 11 is in the imaging mode. The chapter switch 20 is for setting section to image data. The automation setting switch 21 is for performing a processing for setting various items such as, for example, luminosity sensitivity, or brightness automatically when a subject is imaged. The still image imaging switch 22 is for performing switching to a still image imaging.

Further, the display panel 14 is a display module on the digital video camera 11 and it is openable and closable to the camera main body 13. The display panel 14 is ordinarily received in a recessed portion formed on a side face of the camera main body 13 and it is opened at a use time as illustrated. The display panel 14 can be rotated utilizing its longitudinal direction as an axis.

The display panel 14 is provided with a liquid crystal monitor. The liquid crystal monitor is for displaying video being imaged by the digital video camera 11, and it is constituted of a Hi-vision screen with an aspect ratio of 16:9. An outer frame of the liquid crystal monitor on the display panel 14 is provided with a jog dial 23, a menu switch 24, a multifunction switch 25, and the like.

The jog dial 23 is for performing selection operation for selecting one function from various functions and it comprises, for example, a rotatable dial plate. The menu switch 24 is for causing the liquid crystal monitor to display various menus. The multifunction switch 25 includes an arrow key function and allows selection operation for selecting one from various functions, where respective portions of the left, right, top, and bottom can be operated in a pressing manner.

The multifunction switch 25 includes an OK key and the OK key is for deciding selection operation for selecting one function from various functions, and it is provided at the center of the arrow key. Incidentally, by providing the jog dial 23 and the multifunction switch 25 adjacent to each other, the OK key can be easily operated after operating the jog dial 23.

A user supports the camera main body 13 stably with his/her right hand and supports a frame of the display panel 14 with his/her left hand. Then, the user can select the menu switch 24, the jog dial 23, and the multifunction switch 25 arbitrarily to operate them with his/her left-hand thumb, which results in excellence in operability.

Incidentally, the lens module 15 is for imaging video and it includes an imaging lens for receiving an optical image from a subject.

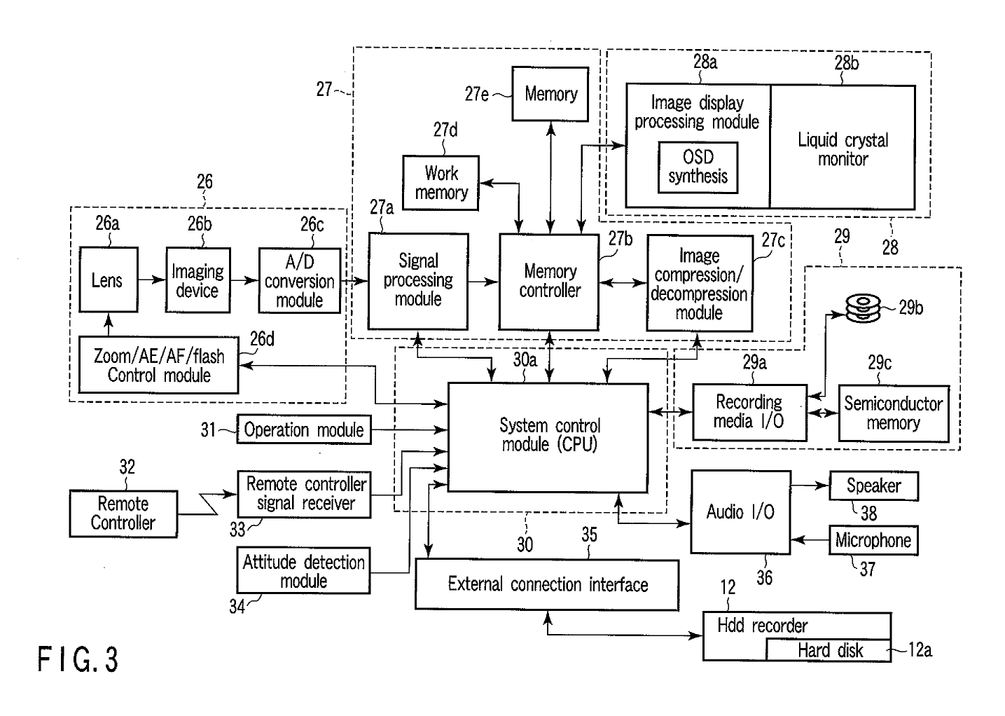

FIG. 3 shows respective block configurations about an optical system and an electric system of the abovementioned digital video camera 11. That is, the digital video camera 11 is mainly provided with an image taking-in module 26, an image data processing module 27, a display module 28, a storage module 29, a control module 30, and the like.

The image taking-in module 26 is provided with an imaging lens 26a, an imaging device 26b, an A/D (analog/digital) conversion module 26c, and a control module 26d. After an optical image of a subject taken in from the imaging lens 26a is formed an image on a imaging surface of the imaging device 26b such as, a CCD (charge coupled device) to be converted to an electric signal and the electric signal is converted to a digital signal by the A/D conversion module 26c, the digital signal is input into a signal processing module 27a positioned at a downstream stage. The control module 26d can perform zooming adjustment, automatic alias adjustment (AE), automatic focusing adjustment (AF), flashing control, and the like.

The image data processing module 27 is provided with a signal processing module 27a, a memory controller 27b, an image compression/decompression module 27c, a work memory 27d, and a memory 27e. The signal processing module 27a performs gamma (γ) correction, color signal separation, white balance adjustment, and the like to image data supplied from the image taking-in module 26.

When an imaging start operation (shutter operation) in a normal imaging state is performed, image data from the signal processing module 27a is input into an image display processing module 28a via the memory controller 27b. When the imaging start operation (shutter operation) is performed, the image data is subjected to an image compression according to, for example, JPEG (joint photographic experts group) system in the image compression/decompression module 27c for storing the image data in the storage module 29 to be converted to image data for display.

The work memory 27d is utilized when image data is edited, a thumbnail image is prepared, or the order of images is changed. That is, the work memory 27d has a function serving as a temporary storage module storing image data to be processed temporarily. Further, the work memory 27d is utilized when various icons are edited. The work memory 27d can save image data corresponding to one screen or image data corresponding to several screens. Image data saved in the work memory 27d is input into the image display processing module 28a via the memory controller 27b.

The display module 28 is provided with the image display processing module 28a and a liquid crystal monitor 28b. The image display processing module 28a performs a conversion processing for displaying on the liquid crystal monitor 28b to the received image data for display, OSD (on screen display) synthesizing processing for synthesizing various display parts (icon and the like) such as a menu or like to supply the processed data to the liquid crystal monitor 28b. The liquid crystal monitor 28b sequentially displays the received image data for display. Thereby, an image being imaged or a subject image targeted in standby state is displayed on the liquid crystal monitor 28b.

The storage module 29 is provided with a record media I/O (input/output) 29a. The record media I/O 29a can conduct write and read of data to a recording medium (record media) such as a hard disk 29b, a semiconductor memory 29c. In this case, the record media I/O 29a stores image data for record on a recording medium under control of the control module 30.

When the record media I/O 29a reads image data for record stored in the recording medium under control of the control module 30, the image data for record is subjected to a decompressing in the image compression/decompression module 27c to be converted to image data for display and the converted image data is input into the image display processing module 28a via the memory controller 27b. That is, a reproduced image is displayed on the liquid crystal monitor 28b.

Incidentally, the recording media is not limited to the abovementioned one, but for example, it may be an optical disk such as a DVD (digital versatile disk).

The control module 30 is provided with a system control module 30a. The system control module 30a is for controlling operations of the whole digital video camera 11 in an integral manner, and it comprises a CPU (central processing unit), a buffer memory such as a RAM (random access memory) functioning as a working area for the CPU, and a program memory such as a ROM (read only memory) in which various programs executed by the CPU, control data, and the like are recorded. In the system control module 30a, various functions are realized by the CPU executing programs stored in the program memory.

The digital video camera 11 is provided with an operation module 31, a remote controller signal receiving module 33 receiving operation information transmitted from a remote controller 32, an attitude detection module 34, an external connection interface 35, an audio I/O 36, a microphone 37, a speaker 38, and the like.

The operation module 31 names generally various switches disposed on the camera main body 13 and the display panel 14. The remote controller signal receiving module 33 is for receiving operation information output from the external remote controller 32. The control module 30 conducts control so as to reflect operation information received from the operation module 31 and the remote controller signal receiving module 33 on the whole apparatus.

The attitude detection module 34 is for detecting inclination of the main body of the digital video camera 11 to a horizontal plane. The attitude detection module 34 comprises angle detection devices such as, an inclined angle sensor, a horizontal level detection circuit, or a gyro sensor. That is, the attitude detection module 34 detects an inclination (attitude) about an optical axis of light received by the imaging lens 26a at an imaging time to the left side or the right side and converts the detected attitude detection signal to a digital signal to transmit the same to the control module 30.

The external connection interface 35 is an interface which is connectable to an external device such as, a PC (personal computer), a television broadcasting receiver, the abovementioned HDD recorder 12, and it comprises a digital interface such as a LAN (local area network), a USB (universal serial bus), and a HDMI (high definition multimedia interface).

The microphone 37 is for inputting audio during edition of videos or at an imaging time. Audio taken in by the microphone 37 is input into the control module 30 via an audio I/O 36 as audio data. The control module 30 can record the received audio data on the recording medium in a paired manner with shot image data for record.

When recorded audio data is reproduced, the control module 30 can read audio data from the recording medium together with the shot image data for record to output audio from the speaker 38 via the audio I/O 36 while reproducing images. Incidentally, when an image is reproduced and confirmed, it is possible to mute audio.

FIG. 4 shows a blocked function performed by the abovementioned system control module 30a. An imaging control module 30b sets an imaging mode according to operation input to control respective modules for taking in acquired image data. A reproduction control module 30c sets a reproduction mode according to operation input. A displaying control module 30d displays image data for display input from the image data processing module 27 on the liquid crystal monitor 28b.

A recording control module 30e controls respective modules such that acquired image data is compressed at the image data processing module 27 to be converted to image data for record and the image data for record is recorded on a selected record media. An operation input determination module 30f analyzes an operation signal input from the operation module 31 or the remote controller signal receiving module 33 to determine operation content.

A display part selection module 30g selects an arbitrary part (an icon, a mark or the like) to be displayed on a menu screen or the like. Respective display parts are stored in a memory or the image display processing module 28a.

A display part movement processing module 30h controls movement, erase or the like of a display part in response to operation input. A highlight (cursor) position control module 30i controls a display position of a highlight position (a cursor position) in response to operation input. A function setting module 30j as well as a setup module 30k is a module for setting various functions on the digital video camera 11. A basic processing control module 30l is a module for controlling basic operation functions, for example, a data transfer function, a read function, a timing setting function, and the like.

A thumbnail control module 30m performs control on preparation, display, scroll, and the like of thumbnail images. A chapter control module 30n includes a chapter managing function and it performs production of a chapter, setting of a typical image of a chapter and preparation of a thumbnail-sized image of the typical image. An attitude information processing module 30o calculates an inclination, namely an angle of the digital video camera 11 main body to a horizontal plane based upon an attitude detection signal from the attitude detection module 34.

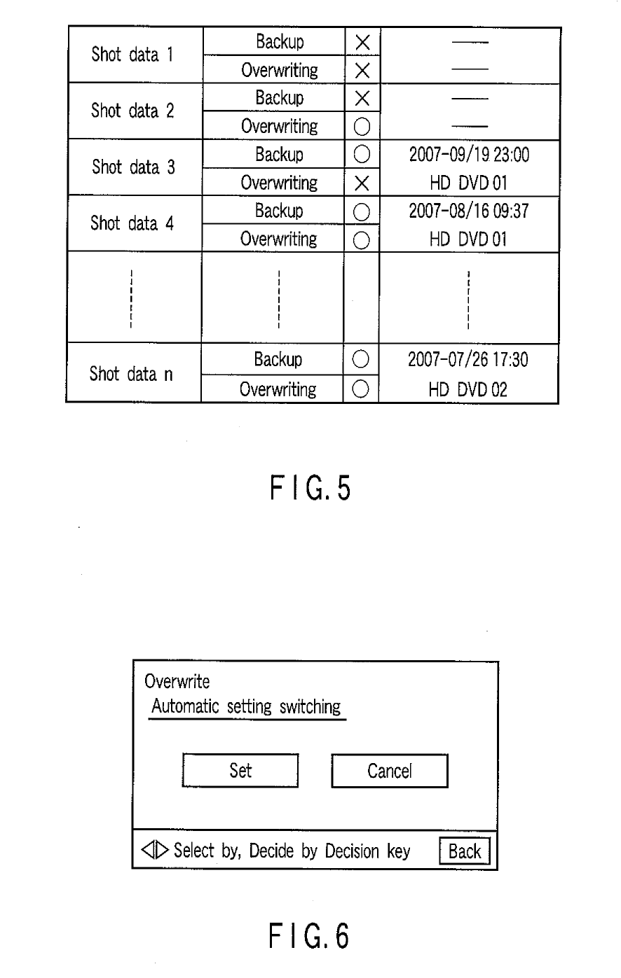

The system control module 30a is provided with a backup management control module 30p As shown in FIG. 5, the backup management control module 30p manages a backup flag indicating whether backup has been completed to all image data items 1, 2, . . . , n recorded in the hard disk 29b of the digital video camera 11, information showing backup destination and date of each image data item if backup has been completed, and an overwrite flag showing whether overwriting can be performed on a record region on the hard disk 29b where the image data items have been recorded in a corresponding manner.

The backup flag is automatically set based upon that a image data item recorded on the hard disk 29b of the digital video camera 11 has been required to be backed up by the hard disk 12a of the HDD recorder 12 and a backup completion has been returned from the HDD recorder 12.

The information showing backup destination and date is set based upon the backup destination (the HDD recorder 12 in this case) set by a user and the date at which the backup has been performed.

Further, regarding the overwrite flag, according to setting of an overwrite automatic setting state conducted by a user, a region on the hard disk 29b where the backup flag is ON, namely, the image data which has been backed up has been recorded can be automatically set in an overwrite ON state, namely, in a state where overwriting can be performed.

Incidentally, by cancelling the overwrite automatic setting state, a use can set the overwrite flag to ON or OFF to each image data item freely.

Thereby, regarding respective image data items recorded on the hard disk 29b of the digital video camera 11, four states of

a state where the backup flag is OFF (x in FIG. 5) and the overwrite flag is also OFF (x in FIG. 5), namely, the backup has not been performed and overwriting is impossible,

a state where the backup flag is OFF and the overwrite flag is ON (O in FIG. 5), namely, the backup has not been performed but overwriting is possible,

a state where the backup flag is ON (O in FIG. 5) and the overwrite flag is OFF, namely, the backup has been performed but overwriting is impossible, and

a state where the backup flag is ON and the overwrite flag is also ON, namely, the backup has been performed and overwriting is possible

can be set.

Setting and cancelling of the overwrite automatic setting state can be realized according to a process where a user operates the menu switch 24 to enter a menu screen with a hierarchical structure and reach an overwrite automatic setting switching screen as shown in FIG. 6 and selects one of the items “set” and “cancel” on the screen to made decision by the multifunction switch 25.

A management list shown in FIG. 5 and prepared by the backup management control module 30p can be displayed on the liquid crystal monitor 28b of the display panel 14 according to a user's request. A user can easily grasp whether each image data item recorded on the hard disk 29b of the digital video camera 11 has been backed up and whether overwriting (erasing) can be performed.

By maintaining the overwrite automatic setting state, each time when a user conducts backup of a image data item recorded on the hard disk 29b of the digital video camera 11, the overwrite flag to the image data item is automatically turned ON so that a state where overwriting can be performed is obtained. As a result, it is unnecessary for a user to erase a image data item which has been backed up from the hard disk 29b or set an overwrite-enabling state manually, which results in handling convenience for the user.

Further, since a user can cancel the overwrite flag set in the overwrite automatic setting state to set ON/OFF of the overwrite flag manually, it is possible to set the overwrite flag to each image data item along user's request, so that handling convenience for a user regarding such a point can be achieved.

In this case, since the user is only required to manually change setting of only an overwrite flag undesired by the user of overwrite flags set in the overwrite automatic setting state, a user's operation is simple, so that handling convenience for a user regarding such a point can be achieved.

Since a image data item which has been backed up is mainly a target to be overwritten, a image data item which has not been backed up can be prevented from being overwritten and erased erroneously as much as possible.

Incidentally, backup to a image data item recorded on the hard disk 29b of the digital video camera 11 is performed according to a user's operation, but such an configuration can be adopted that a cradle (not shown) loaded with the digital video camera 11 for performing charging is connected with a recording apparatus and when a user loads the digital video camera 11 on the cradle, an image data item which has been recorded on the hard disk 29b but has not been backed up is automatically recorded on the recording apparatus via the cradle to be backed up.

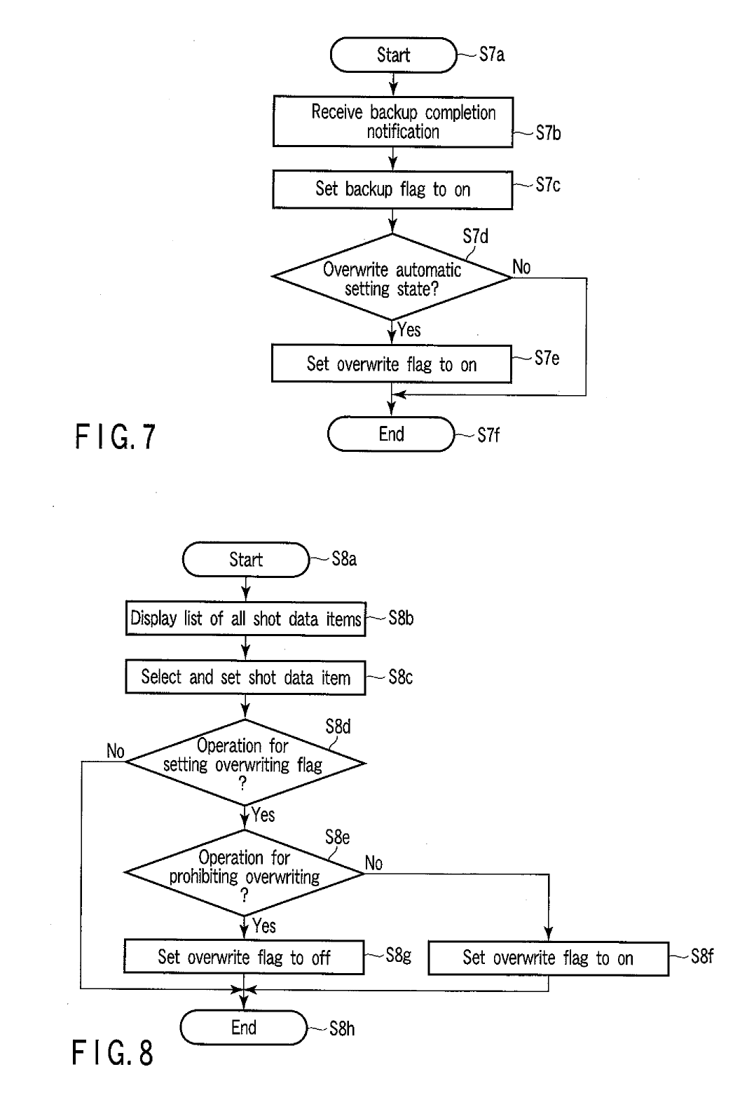

FIG. 7 shows a flowchart collectively showing a processing operation for automatically setting an overwrite flag on a recording region on the hard disk 29b regarding a image data item which has been backed up. That is, a processing is started (Step S7a), and when backup of a predetermined image data item recorded on the hard disk 29b of the digital video camera 11 to the hard disk 12a of the HDD recorder 12 is performed so that a backup completion notification is returned from the HDD recorder 12 at Step S7b, the backup management control module 30p sets the backup flag to the image data item which has been backed up to ON at Step S7c.

Thereafter, the backup management control module 30p determines whether setting to the overwrite automatic setting state has been made at Step S7d and it terminates the processing when the determination is negative (NO) (Step S7f).

When the determination is affirmative (YES) at Step S7d, the backup management control module 30p sets the overwrite flag to the image data item which has been previously backed up to ON at Step S7e and terminates the processing (Step S7f).

FIG. 8 is a flowchart collectively showing a processing operation for a user to set ON/OFF of the overwrite flag. That is, when a processing is started (step S8a), the backup management control module 30p displays a management list of all image data items such as, for example, shown in FIG. 5 on the display panel 14 at Step S8b.

When a predetermined image data item is selected from the management list by a user at Step S8c, the backup management control module 30p determines whether an operation for setting an overwrite flag has been required by the user at Step S8d, and when the determination is negative (NO), the backup management control module 30p terminates the processing (Step S8h)

When the determination is affirmative (YES) at the abovementioned Step S8d, the backup management control module 30p determines whether an operation for prohibiting overwriting has been required by the user at Step S8e, and when the determination is negative (NO), the backup management control module 30p sets the overwrite flag to the image data previously selected and set by the user to ON at Step S8f to terminate the processing (Step S8h).

Further, when the determination is affirmative (YES) at Step S8e, the backup management control module 30p sets the overwrite flag to the image data previously selected and set by the user to OFF at Step S8g to terminate the processing (Step S8h).

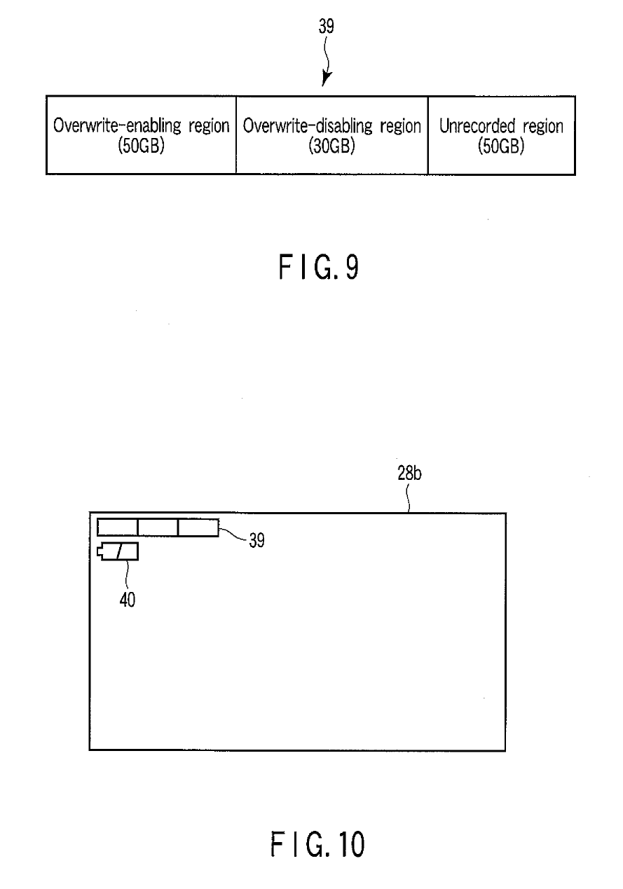

Here, the backup management control module 30p performs the remaining amount display 39 such as shown in FIG. 9 on the liquid crystal monitor 28b of the display panel 14 based upon the prepared management list. The remaining amount display 39 is shown while the whole recording region on the hard disk 29b of the digital video camera 11 provided to the user is divided to a region set to enable overwriting, a region set to disable overwriting, and a unrecorded region where no recording has been conducted.

The three regions are displayed in a state that they are separated by color or they are sectioned by characters according to the liquid crystal monitor 28b of the display panel 14. In the example of the remaining amount display 39 shown in FIG. 9, such a fact that in 130 GB contained in the hard disk 29b which is the capacity of the whole recording region provided to a user, a capacity of the overwrite-enabling region is 50 GB, a capacity of the overwrite-disabling region is 30 GB, and a capacity of the unrecorded region is 50 GB is shown, and such a fact that 100 GB obtained by adding the capacities of the overwrite-enabling region and the unrecorded region is a recordable capacity is shown.

The unrecorded region shows a free region where no image data has been written. The capacity of the unrecorded region decreases according recording of image data and a capacity corresponding to the decrease is added to the overwrite-disabling region. When image data in one of the overwrite-enabling region and the overwrite-disabling region is erased, the capacity of the unrecorded region increases correspondingly.

The overwrite-disabling region is a recorded region of image data where the overwrite flag has been set to OFF. The capacity of the overwrite-disabling region increases according to recording of new image data, and it deceases according to sequential ON setting of the overwrite flags of respective image data items recorded in the overwrite-disabling region.

The overwrite-enabling region is a region where, when the capacity of the unrecorded region becomes 0 or a predetermined capacity or less, overwriting is started. The capacity of the overwrite-enabling region increases according to sequential ON setting of the overwrite flags of respective image data items recorded in the overwrite-disabling region, while it decreases by overwriting execution.

According to the remaining amount display 39 shown in FIG. 9, the respective capacities of the overwrite-enabling region, the overwrite-disabling region, and the unrecorded region can be easily grasped visually. Therefore, for example, when the capacity of the overwrite-disabling region increases or when the capacity of the unrecorded region decreases, a user can increase the capacity of the overwrite-enabling region easily to secure the recording capacity by backing up image data recorded on the overwrite-disabling region to allow overwriting, which can result in handling convenience for a user.

As shown in FIG. 10, it is desirable practically to adopt a display form where the remaining amount display 39 of the recording capacity of the hard disk 29b together with, for example, a power consumption display 40 of battery power is always performed regardless of during imaging and during reproduction on the liquid crystal monitor 28b of the display panel 14.

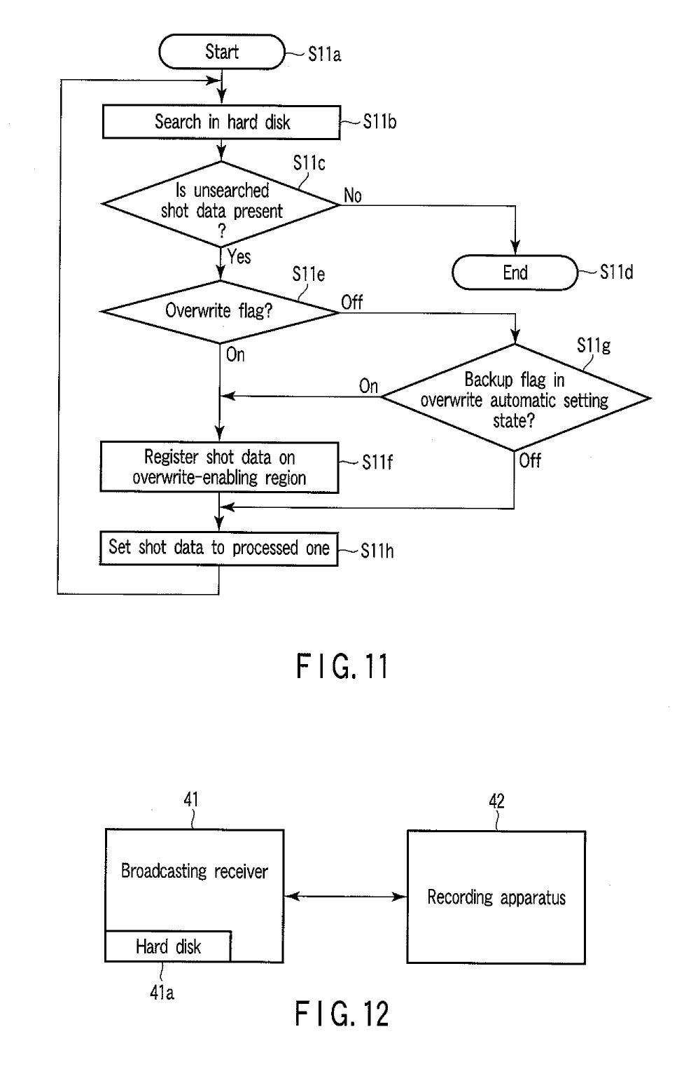

FIG. 11 is a flowchart collectively showing a processing operation where the backup management control module 30p takes out a data item which can be registered in the overwrite-enabling region from all the image data items recorded on the hard disk 29b based upon the management list prepared by the backup management control module 30p. That is, when a processing is started (Step S11a), the backup management control module 30p conducts search in the hard disk 29b at Step S11b, determines whether an unsearched image data item is present at Step S11c, and terminates the processing when the determination is negative (NO) (Step S11d).

When the determination is affirmative (YES) at the abovementioned Step S11c, the backup management control module 30p takes out one image data item from unsearched image data items based upon the preset priority order to make determination about the overwrite flag attached to the image data item at Step S11e.

When it is determined that the overwrite flag is ON at Step S11e, the backup management control module 30p registers the image data item on the overwrite-enabling region at Step S11f. When it is determined that the overwrite flag is OFF at the abovementioned Step S11e, the backup management control module 30p makes determination about the backup flag attached to the image data item in the abovementioned overwrite automatic setting state, namely, in a state set so as to automatically allow overwriting on the recording region on the hard disk 29b for the image data item backed up, and when it is determined that the backup flag is ON at Step S11g, the backup management control module 30p registers the image data item on the overwrite-enabling region at Step S11f.

After Step S11f, when setting to the overwrite automatic setting state is not performed at the abovementioned Step S11g, or when it is determined that the backup flag attached to the image data item is OFF, the backup management control module 30p sets the image data item to a processed one at step S11h to return back to the processing at Step S11b.

Now, in the abovementioned embodiment, explanation about the setting of the overwrite region on the hard disk 29b of the digital video camera 11 which is the imaging apparatus and the remaining amount display when image data recorded on the hard disk 29b is backed up to an external recording apparatus has been made. However, the present invention is not limited to this embodiment and setting of an overwrite region and a remaining amount display according to management similar to the abovementioned embodiment can also be performed in such a system that data such as a program received at a broadcasting receiver 41 and recorded on a hard disc 41a incorporated in the receiver is backed up to an external recording apparatus 42, such as shown in FIG. 12, for example, of course.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging apparatus comprising:
a recording module configured to record image data;
a communication module configured to transmit the image data to an external recording apparatus for backup;
a generating module configured to generate a management list comprising information indicating whether the image data has been backed up; and
a display configured to display the management list.

2. The imaging apparatus of claim 1, wherein
the generating module is configured to produce the information indicating whether the image data has been backed up based upon a backup completion notification received from the external recording apparatus via the communication module.

3. The imaging apparatus of claim 1, wherein
the management list further comprises information indicating whether overwriting can be performed on a region where the image data has been recorded based upon the information indicating whether backup has been performed.

4. The imaging apparatus of claim 3, wherein
the generating module is configured to associate information indicating that overwriting can be performed on the recorded region and the information indicating that the image data has been backed up.

5. The imaging apparatus of claim 3, wherein
the generating module is configured to change the information indicating whether overwriting can be performed on the management list in accordance with an input.

6. The imaging apparatus of claim 3, wherein
the management list further comprises information indicating a backup destination and date of the image data.

7. The imaging apparatus of claim 3, wherein
the generating module is configured to divide the recorded region into an overwrite-enabled region, an overwrite-disabled region, and an unwritten region based upon the information indicating whether overwrite can be performed, and to display capacities of the regions on the display respectively.

8. The imaging apparatus of claim 7, wherein
the generating module is configured to register the recorded region as overwrite-enabled either when the image data is associated with the information indicating that overwriting can be performed or when the region of the backed up image data is automatically set as overwrite-enabled.

9. An information recording apparatus comprising:
a recording module configured to record received data;
a communication module configured to transmit the data to an external recording apparatus for backup;
a generating module configured to generate a management list comprising information indicating whether the image data has been backed up and information indicating whether overwriting can be performed on a recorded region; and
a display configured to display the management list.

10. The information recording apparatus of claim 9, wherein
the generating module is configured to associate information indicating that overwriting can be performed on the recorded region and the information indicating that the image data has been backed up.

11. An information recording method comprising:
recording received data on a recording module;
transmitting the data to an external recording apparatus for backup;
generating a management list comprising information indicating whether the image data has been backed up and information indicating whether overwriting can be performed on a recorded region of the image data; and
displaying the generated management list.

12. The information recording method of claim 11, wherein
the generating further comprising associating information indicating that overwriting can be performed on a recorded region and information indicating that the image data has been backed up.
